(19) United States
(12) Patent Application Publication
(10) Pub. No.: US 2010/0037426 A1
(43) Pub. Date: Feb. 18, 2010

(54) MOBILE CHAIR STOP SYSTEM

(76) Inventors: Michael Robert Mongelluzzo, East Quogue, NY (US); Ron Mongelluzzo, Hampton Bays, NY (US)

Correspondence Address: TUTUNJIAN + BITETTO, P.C., 20 CROSSWAYS PARK NORTH, SUITE 210, WOODBURY, NY, 11797, US

(21) Appl. No.: 12/189,875

(22) Filed: Aug. 12, 2008

(51) Int. Cl. B60B 33/06; A47C 3/00; B60T 1/14; A47C 7/00

(52) U.S. Cl. 16/32; 297/463.1; 188/1.12

(57) ABSTRACT

A stop system for a mobile chair having wheels is provided including a plurality of shroud members configured for covering each radial chair leg of the mobile chair. Each shroud member is movable in a first direction to enable a mobile state of the chair and in a second direction to enable a stationary state of the chair.

### BACKGROUND OF THE INVENTION

1. Technical Field of the Invention

The present invention generally relates to mobile chairs, and, more particularly, to a mobile chair stop mechanism for enabling a mobile chair to be switched between a mobile state and an immobile state when desired.

2. Description of Related Art

There exists today a wide range of mobile chairs, for example, task chairs and office/desk chairs which are adapted to be mobile via swivel casters, wheels, etc. In a typical configuration, a mobile chair is constructed having a seat mounted on a center post which connects to a multi-point mobile base, such as a five leg base having a swivel wheel connected at each leg end for contact with the ground.

Mobility in a chair if often desirable in work situations in which the user must alter their position or location within a space, such as when multitasking between different workstations, adjusting to different locations/work distances at a desk, etc. Chair mobility contributes to ease of use during position changes and reduces strain by encouraging users to change their position frequently and to the most comfortable location, thus allowing users to position their body at different locations with minimal effort.

However, there are some situations in which chair mobility is undesirable, and even dangerous to the user. In certain situations, chair stability is necessary for safety. For instance, if someone needs to stand on the chair for any reason, e.g., to change a light bulb, a mobile chair is unstable and may roll while the user is standing, causing the user to lose balance and fall.

In other instances, a user may desire to set the chair in a fixed or stationary position while sitting, for example, to perform certain tasks which require precision or user stability, for comfort preferences during sitting, or in cases where a user performs exercises in the chair or even using the chair, such as strength, flexibility or resistance exercises.

For optimal flexibility, a user may desire to switch back to a ‘mobile mode’ from a ‘stationary mode’ and vice versa. Alternating between such modes may be performed many times during a typical day, and thus ease of switching between modes is highly desirable.

Accordingly, a need exists for a system and method for efficiently and effectively providing mobile and stationary modes in a single chair in a manner which optimizes convenience and ease of use.

### SUMMARY OF THE INVENTION

The present invention generally relates to chair stop systems, and, more particularly, to a chair stop device and mechanism incorporated into a mobile chair for enabling a stable, non-mobile state to be achieved as desired with optimal convenience, and to enable users to easily alternate between a mobile state and a non-mobile state in a single chair.

The present invention comprises an easy-to-use, durable and secure chair stop mechanism which may be incorporated into any mobile chair having legs with, e.g., swivel casters, wheels, etc. Preferably, a chair stop is provided for each chair leg having mobile capability, and is slidably affixed thereto. Each chair stop includes a stop pad disposed at an end for frictionally contacting the ground during a non-mobile mode. To achieve a non-mobile mode, each chair stop is caused to be extended from each chair leg to enable each stop pad to contact the ground, thus preventing the chair wheels from rolling. To achieve a mobile mode, each chair stop is caused to be retracted to lift each stop pad from the ground, allowing the wheels to roll freely.

Advantageously, the deployment of the mobile and stationary states is such that the extension and retraction of all the chair stops is performed substantially simultaneously.

According to one embodiment, a stop system for a mobile chair having wheels is provided comprising a plurality of shroud members configured for covering each radial chair leg of the mobile chair, each shroud member being movable in a first direction to enable a mobile state of the chair and in a second direction to enable a stationary state of the chair.

According to another embodiment, a chair stop system for a mobile chair is provided comprising a plurality of chair stop members adapted for covering at least a top portions of each radial chair leg of the mobile chair, each chair stop member being slidable in a first direction to enable a mobile state of the chair and in a second direction to enable a stationary state of the chair.

### BRIEF DESCRIPTION OF THE DRAWINGS

In the drawings, wherein like reference numerals denote similar elements throughout the views:

FIG. 1 is an exemplary front perspective view of a chair having a mobile chair stop system in a mobile position according to a first embodiment of the present invention;

FIG. 2 is an exemplary front perspective view of a mobile chair stop system of FIG. 1 in a stationary position according to an aspect of the present invention;

FIG. 3 is an exemplary top perspective view of a mobile chair stop system of FIG. 1 in a mobile position according to an aspect of the present invention;

FIG. 4 is an exemplary top perspective view of a mobile chair stop system of FIG. 1 in a stationary position according to an aspect of the present invention;

FIG. 5 is an exemplary side view of a chair having a mobile chair stop system in a mobile position according to an aspect of the present invention;

FIG. 6 is an exemplary side view of a chair having a mobile chair stop system in a mobile position according to an aspect of the present invention;

FIG. 7 is an exemplary front perspective view of a mobile chair stop system in a mobile position according to a second embodiment of the present invention;

FIG. 8 is an exemplary front perspective view of a mobile chair stop system of FIG. 7 in a stationary position according to an aspect of the present invention;

FIG. 9 is an exemplary front perspective view of a chair having the mobile chair stop system of FIG. 7 in a mobile position according to an aspect of the present invention;

FIG. 10 is an exemplary front perspective view of a chair having the mobile chair stop system of FIG. 7 in a stationary position according to an aspect of the present invention;

FIG. 11 is an exemplary side view of a chair having the mobile chair stop system of FIG. 7 in a mobile position according to an aspect of the present invention;

FIG. 12 is an exemplary side view of a chair having the mobile chair stop system of FIG. 7 in a mobile position according to an aspect of the present invention;

FIG. 13 is an exemplary front perspective view of a mobile chair stop system in a mobile position according to a third embodiment of the present invention;

FIG. 14 is an exemplary front perspective view of a mobile chair stop system of FIG. 13 in a stationary position according to an aspect of the present invention;

FIG. 15 is an exemplary front perspective view of a chair having the mobile chair stop system of FIG. 13 in a mobile position according to an aspect of the present invention;

FIG. 16 is an exemplary front perspective view of a chair having the mobile chair stop system of FIG. 13 in a stationary position according to an aspect of the present invention;

FIG. 17 is an exemplary side view of a chair having the mobile chair stop system of FIG. 13 in a mobile position according to an aspect of the present invention;

FIG. 18 is an exemplary side view of a chair having the mobile chair stop system of FIG. 13 in a mobile position according to an aspect of the present invention;

FIG. 19 is an exemplary front perspective view of a chair having a mobile chair stop system in a mobile position according to a fourth embodiment of the present invention;

FIG. 20 is an exemplary front perspective view of a chair having the mobile chair stop system of FIG. 19 in a stationary position according to an aspect of the present invention;

FIG. 21 is an exemplary side view of a chair having the mobile chair stop system of FIG. 19 in a mobile position according to an aspect of the present invention;

FIG. 22 is an exemplary side view of a chair having the mobile chair stop system of FIG. 19 in a stationary position according to an aspect of the present invention;

FIG. 23 is an exemplary front perspective view of a chair having a mobile chair stop system in a mobile position according to a fifth embodiment of the present invention;

FIG. 24 is an exemplary front perspective view of a chair having the mobile chair stop system of FIG. 23 in a stationary position according to an aspect of the present invention;

FIG. 25 is an exemplary side view of a chair having the mobile chair stop system of FIG. 23 in a mobile position according to an aspect of the present invention; and

FIG. 26 is an exemplary side view of a chair having the mobile chair stop system of FIG. 23 in a stationary position according to an aspect of the present invention.

It should be understood that the drawings are for purposes of illustrating the concepts of the invention and are not necessarily the only possible configurations for illustrating the invention.

### DETAILED DESCRIPTION OF PREFERRED EMBODIMENTS

For explanatory purposes, the embodiments discussed below are described with respect to, e.g., a mobile chair of the type having multiple radial legs attached to and extending from a single center post, each leg having an attached wheel, preferably a swivel wheel.

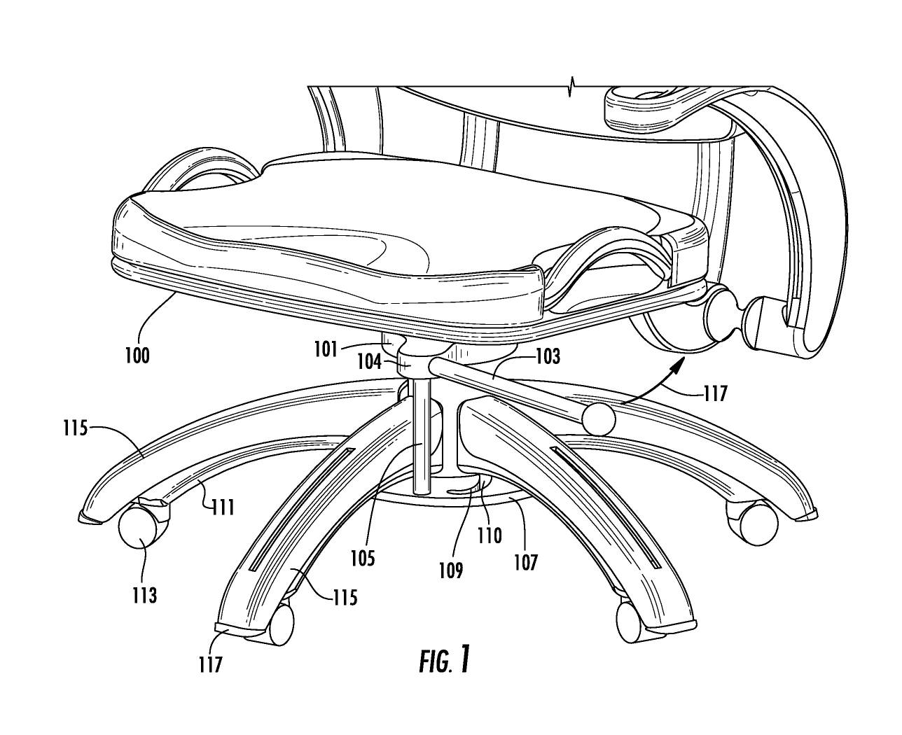

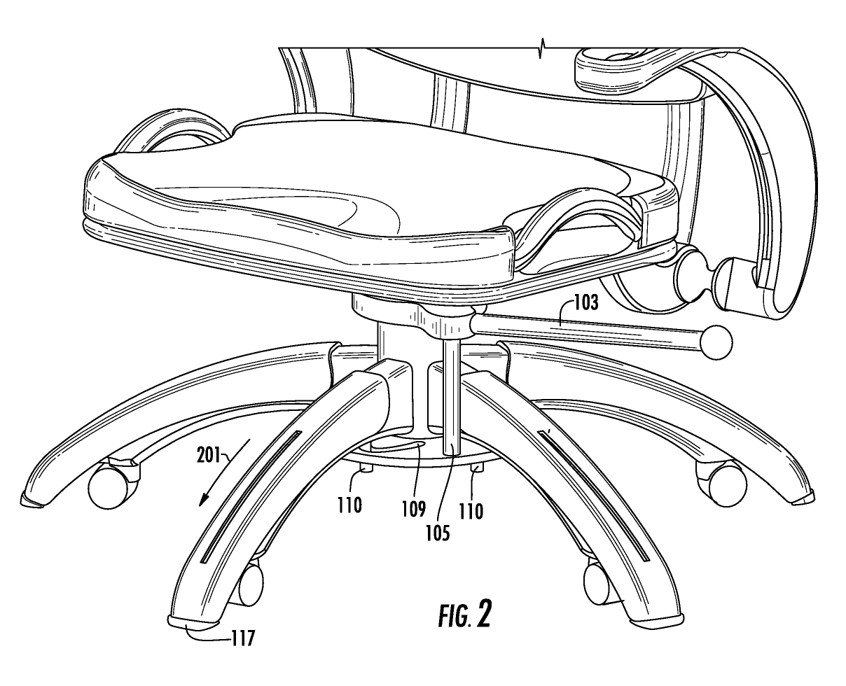

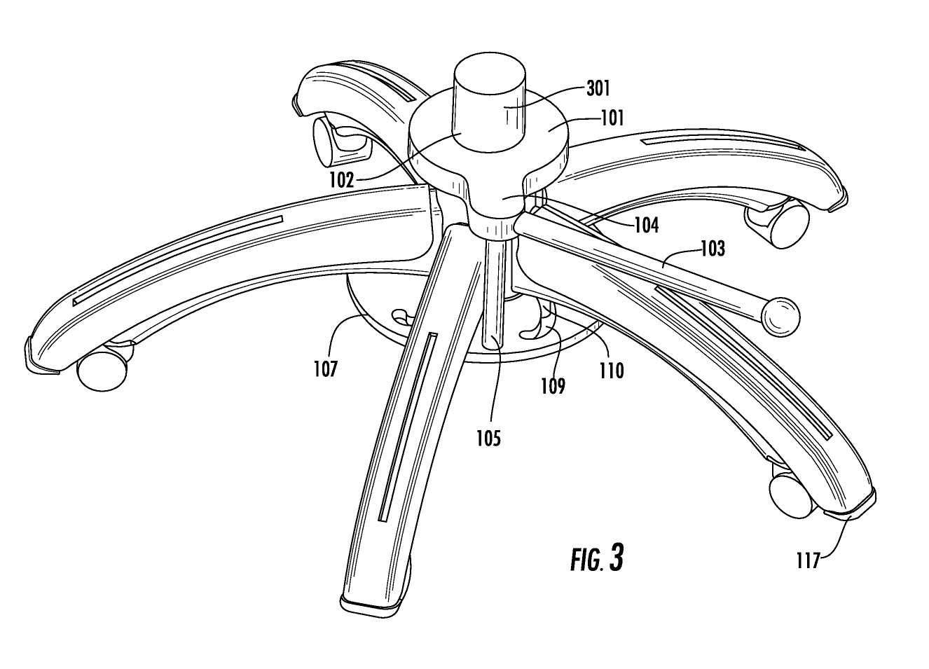

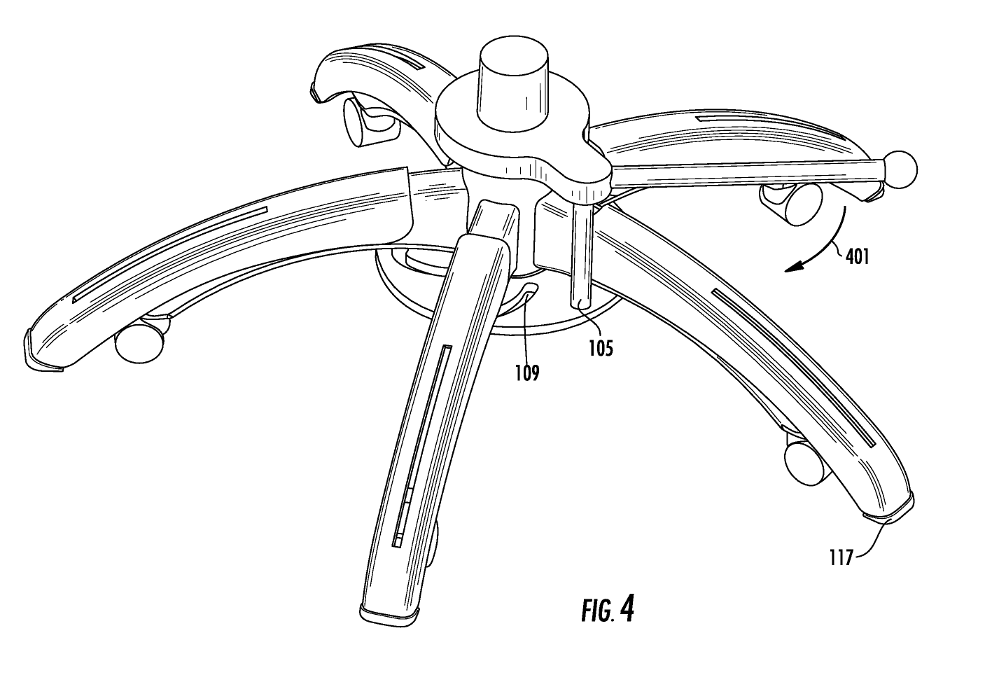

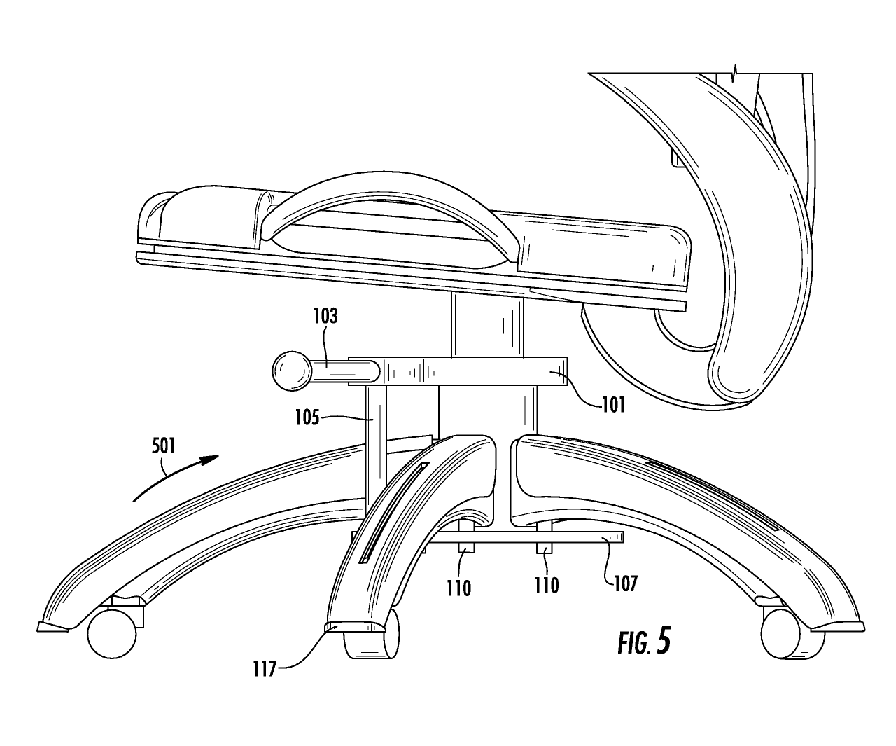

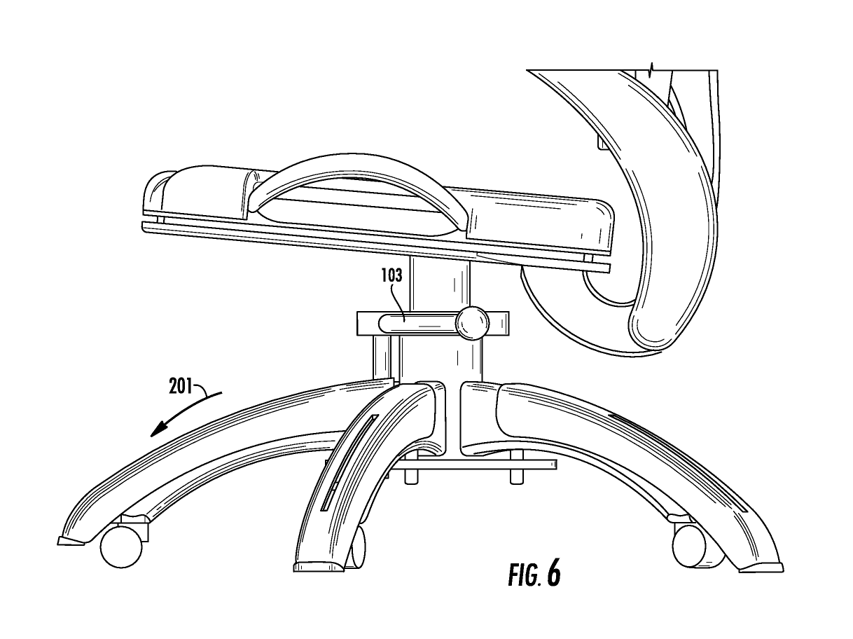

Referring now to the Figures, FIGS. 1-6 are exemplary views of a mobile chair stop system in mobile and stationary positions according to a first embodiment of the present invention. FIGS. 1, 3 and 5 depict a chair in a mobile state, whereas FIGS. 2, 4 and 6 depict a chair in a non-mobile state.

In this exemplary embodiment, a mobile chair stop system is comprised of a cam member 101 having an aperture 102 adapted to allow the cam member 101 to be rotatably installed onto a chair support column 301. The cam member 101 may be comprised, e.g., of a disk-shaped object having, e.g., a circular aperture and a protruding arm 104 to which is attached a lever 103 adapted to extend from the cam member 101 in a sideways or horizontal direction.

The protruding arm 104 may comprise an elongate, curved (e.g., U-shaped) protrusion (although the protrusion may comprise any shape/size) and includes a rod 105 attached thereon at a first end and extending in a downwards vertical direction. The rod 105 may comprise any desired shape and be of a suitable length to connect the cam member 101 with a base member 107. For example, the rod 105 may comprise an elongate cylinder having a second end attached to the base 107.

The base 107 may comprise a flattened disc-shaped element and includes a plurality of voids 109. Preferably, one void may be provided for each radial chair leg; accordingly, in this example showing a five-legged chair, the base 107 shown in FIGS. 1-6 includes five voids. The voids 109 may be of any shape or size and are preferably adapted to slidably receive an anchor element 110 inserted within. In one preferred embodiment as shown, each void 109 may preferably comprise an elongate curved shape.

Preferably, the lever 103 is provided extending from the arm 104 at any desired angle and/or at any desired length so as to facilitate convenient user access and handling of the lever 103 while preventing interference with any other chair parts and/or the legs of the user while the user is seated.

A plurality of chair stops 115 are provided, one for each radial chair leg 111. Each chair stop 115 comprises a sheath-like member adapted to substantially extend along the length of each chair leg 111 and be slidable relative to each chair leg. That is, each chair stop 115 is adapted to be slidable relative to a longitudinal axis of each chair leg 111. Preferably, each chair stop 115 is shaped to the contours of each radial leg 111 and in one embodiment, extends over at least the top surface of each leg 111.

Preferably, each chair stop 115 is slidably affixed to each chair leg 111. A track system provided along at least a partial length of each chair leg 111, or any other suitable system may be provided for enabling slidable attachment between each chair stop 115 and each chair leg 111.

Further, each chair stop 115 includes an anchor leg 110 having a first end functionally affixed to the chair stop 115, the anchor leg 110 being comprised of an elongate rod whose free end is adapted to be insertable within one of the voids 109.

Each chair stop preferably includes a stop pad 117 disposed at each end for frictionally contacting the ground when a non-mobile mode of the chair is enabled. The stop pad 117 may be comprised of a grip-able material, such as, e.g., rubber, silicone and the like, for maximizing frictional resistance when contacted with the ground.

To achieve a non-mobile mode, each chair stop is caused to be extended radially in a outwards direction, e.g., away from the chair support column 301, to enable each stop pad to contact the ground, thus preventing the chair wheels from rolling. According to one embodiment as shown in FIGS. 1-6, each chair stop is caused to be simultaneously extended by a series of mechanical events, e.g., by moving the lever 103 in a sideways direction 117, for example, here in a counterclockwise direction. This causes cam member 101 to rotate, e.g., in a corresponding counterclockwise direction, and displaces the rod 105, causing the base 107 attached to the rod to rotate as well. The rotation of the base 107 causes each inserted anchor leg 110 to be slid along each void 109 from a first position (as shown in FIGS. 1, 3 and 5) to a second position (as shown in FIGS. 2, 4 and 6).

The movement of each anchor leg 110 causes a force to be imparted on each chair stop 115, pushing each chair stop 115 radially outwards in direction 201. Each chair stop 115 is caused to be extended for a suitable distance, such distance preferably sufficient to cause the ends of each chair stop 115 to firmly contact the floor or ground to achieve a secure grip. Preferably, each chair stop end includes a stop pad 117 to improve frictional grip and stability.

To achieve a mobile mode, each chair stop 115 is caused to be retracted to lift each stop pad 117 from the ground, thus allowing the wheels to roll freely. To return to a mobile mode from a non-mobile mode, essentially a reverse series of events is carried out, namely, according to one embodiment as shown in FIGS. 1-6, each chair stop is caused to be simultaneously retracted by a series of mechanical events, e.g., by moving the lever 103 in a sideways direction 401, for example, here in a clockwise direction. This causes wheel member 101 to rotate, e.g., in a clockwise direction, and displaces the rod 105, causing the base 107 attached to the rod to rotate as well. The rotation of the base 107 causes each inserted anchor leg 110 to be slid along each void 109 from the second position (as shown in FIGS. 2, 4 and 6) back to the first position (as shown in FIGS. 1, 3 and 5).

The movement of each anchor leg 110 causes a force to be imparted on each chair stop 115, pushing each chair stop 115 inwards in direction 501. Each chair stop 115 is caused to be retracted for a suitable distance, such distance preferably sufficient to cause the ends of each chair stop 115 to release any contact with the floor or ground, thus allowing the chair wheels 113 to roll freely.

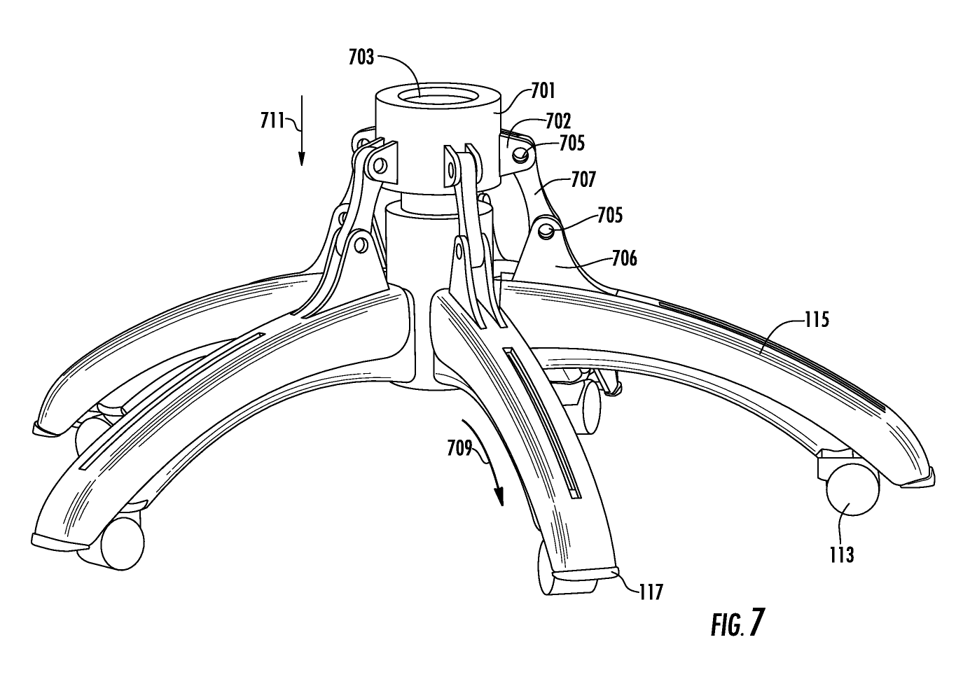

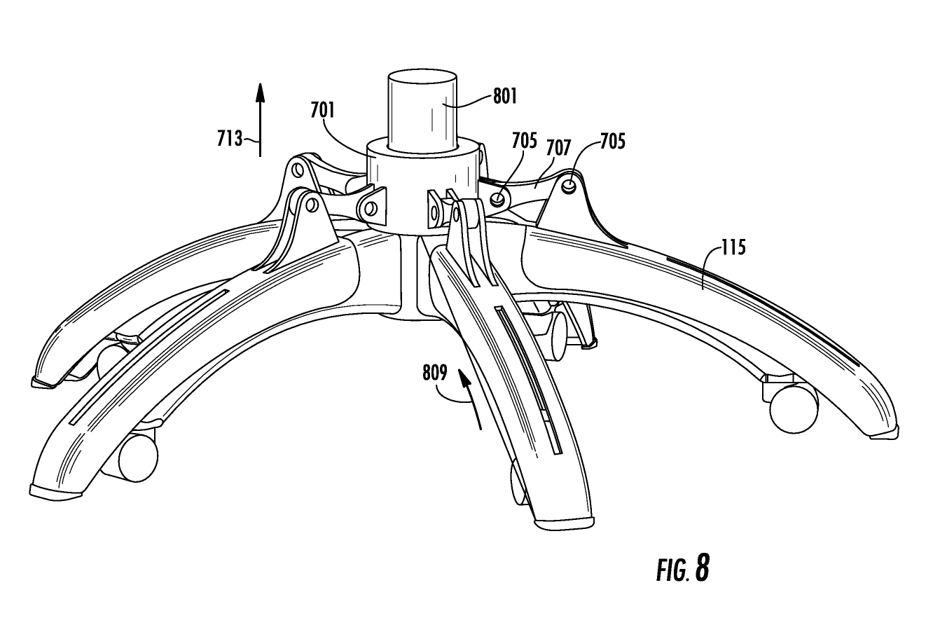

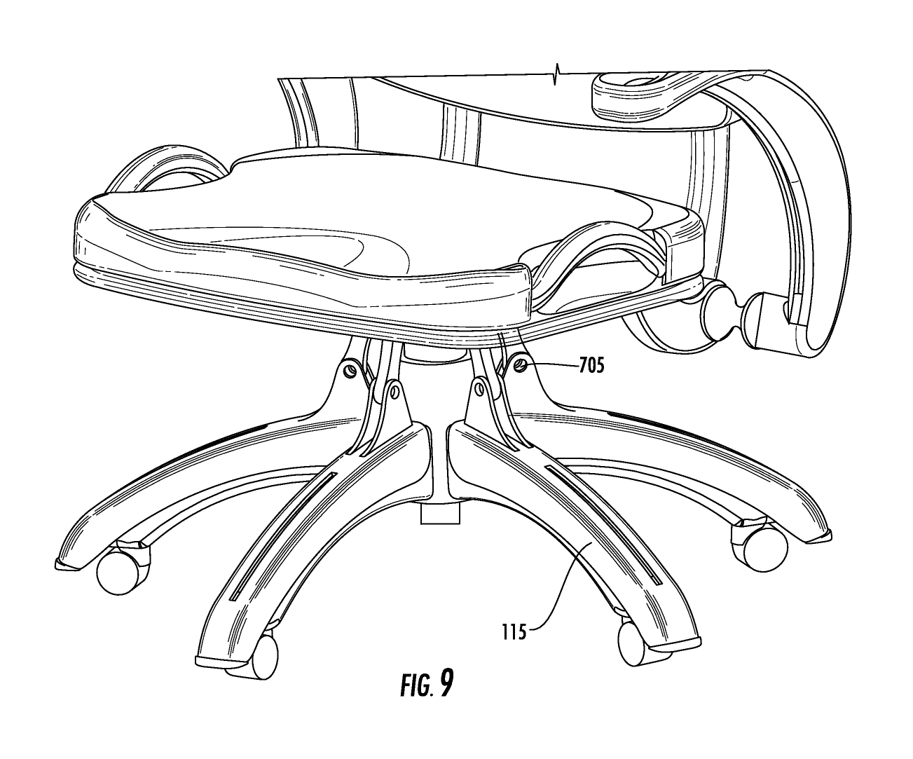

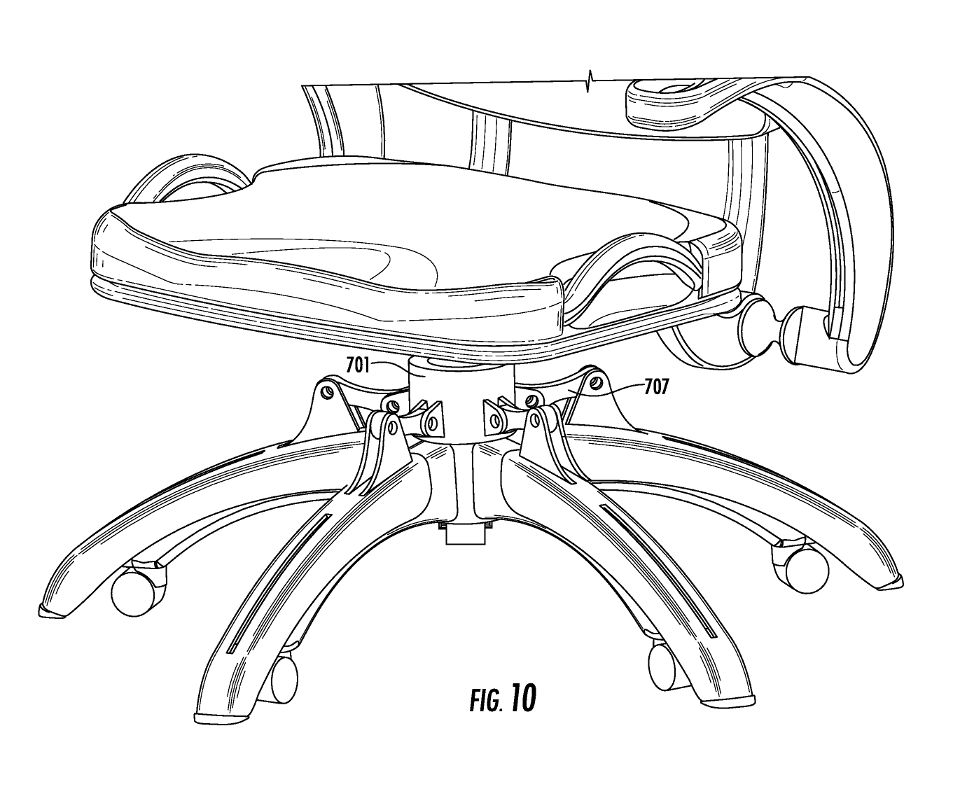

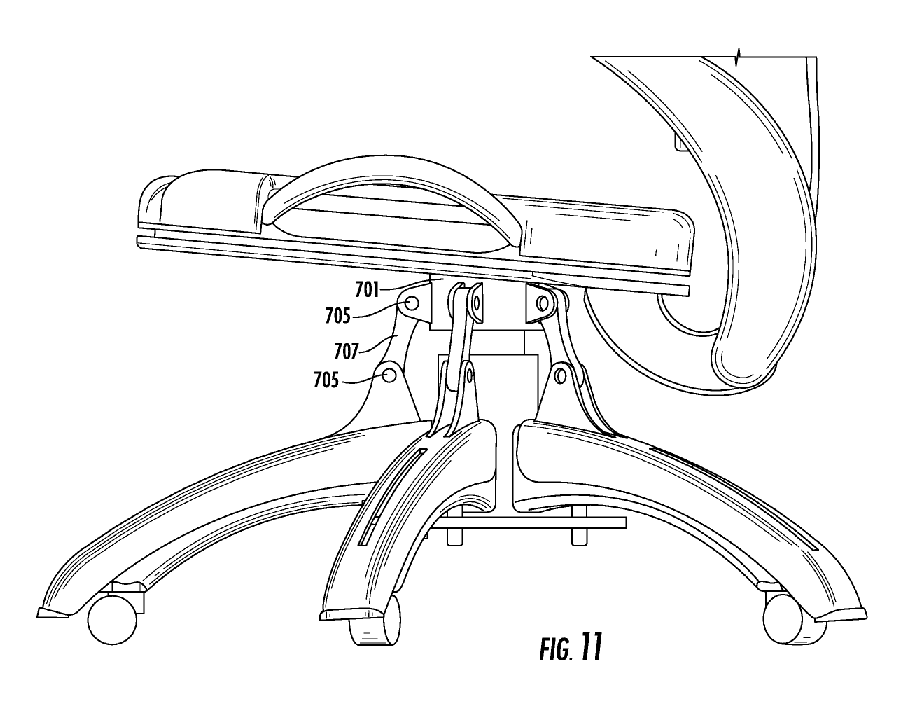

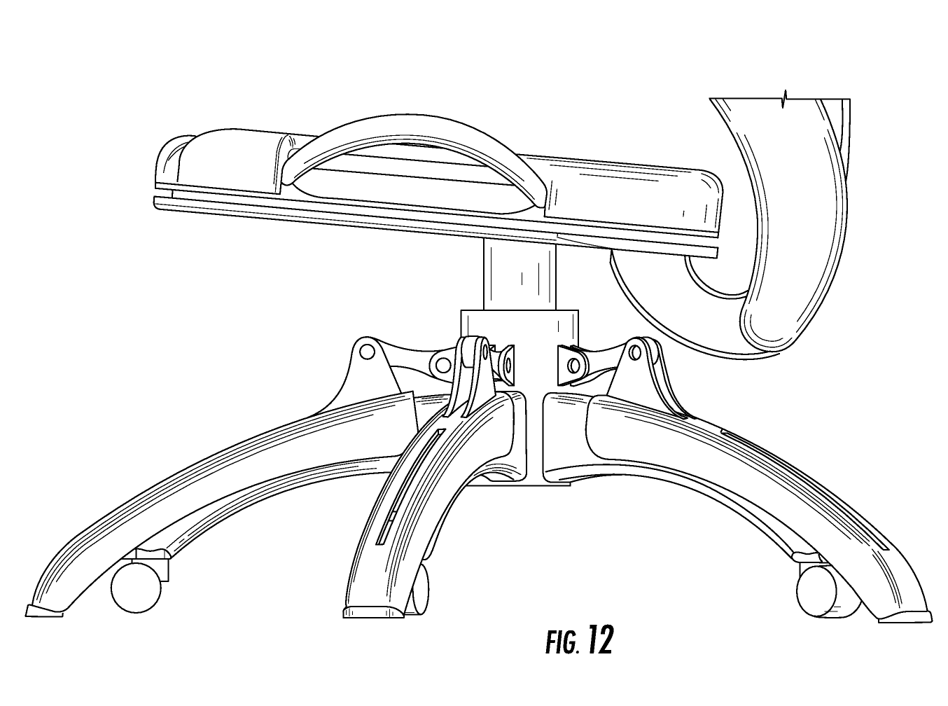

FIGS. 7-12 are exemplary views of a mobile chair stop system in mobile and stationary positions according to a second embodiment of the present invention. This embodiment depicts an exemplary “cylinder push system” for enabling the mobile and stationary positions. FIGS. 7, 9 and 11 depict a chair in a mobile state, whereas FIGS. 8, 10 and 12 depict a chair in a non-mobile state.

In this exemplary embodiment, a mobile chair stop system is comprised of a cylinder member 701 having an aperture 703 adapted to allow the cylinder member 701 to be slidably installed onto a chair support column 801. The cylinder member 701 is adapted to be slidable along the chair support column 801, and includes a plurality of cylinder attachment points 702 which permit jointed connection of chair stops 115. For example, such jointed connection may be achieved via provision of a center arm 707 having a first end pivotally connected to a cylinder attachment point 702, and a second end pivotally coupled to a chair stop attachment point 706. Pivot points 705 may comprise any type of jointed coupling enabling movement of the center arm 707 relative to the fixed attachment points 702, 706.

To achieve a non-mobile mode, each chair stop 115 is caused to be extended to enable each stop pad 117 to contact the ground, thus preventing the chair wheels from rolling. According to one embodiment as shown in FIGS. 7-12, each chair stop is caused to be simultaneously extended by a series of mechanical events, e.g., by pushing the cylinder 701 downwards in direction 711. For example, the cylinder 701 may be pushed via directly grasping the cylinder and/or a lever or handle (not shown) may be provided on the cylinder 701 to facilitate gripping.

Pushing the cylinder 701 downwards in direction 711 applies a force through center arm 707, which translates into a force 709 extending each chair stop 115 outwards simultaneously. As described above, each chair stop 115 is caused to be extended for a suitable distance, such distance preferably sufficient to cause the ends of each chair stop 115 to firmly contact the floor or ground to achieve a secure grip. Preferably, each chair stop end includes a stop pad 117 to improve frictional grip and stability.

To achieve a mobile mode, each chair stop 115 is caused to be retracted to be lifted (e.g., to lift each stop pad 117) from the ground, thus allowing the wheels 113 to roll freely. To return to a mobile mode from a non-mobile mode, essentially a reverse series of events is carried out, namely, according to one embodiment as shown in FIGS. 7-12, each chair stop is caused to be simultaneously retracted by a series of mechanical events, e.g., by pushing the cylinder 701 upwards in direction 713.

This causes each chair stop 115 to be pulled inwards in direction 809. Each chair stop 115 is caused to be retracted for a suitable distance, such distance preferably sufficient to cause the ends of each chair stop 115 to release any contact with the floor or ground, thus allowing the chair wheels 113 to roll freely.

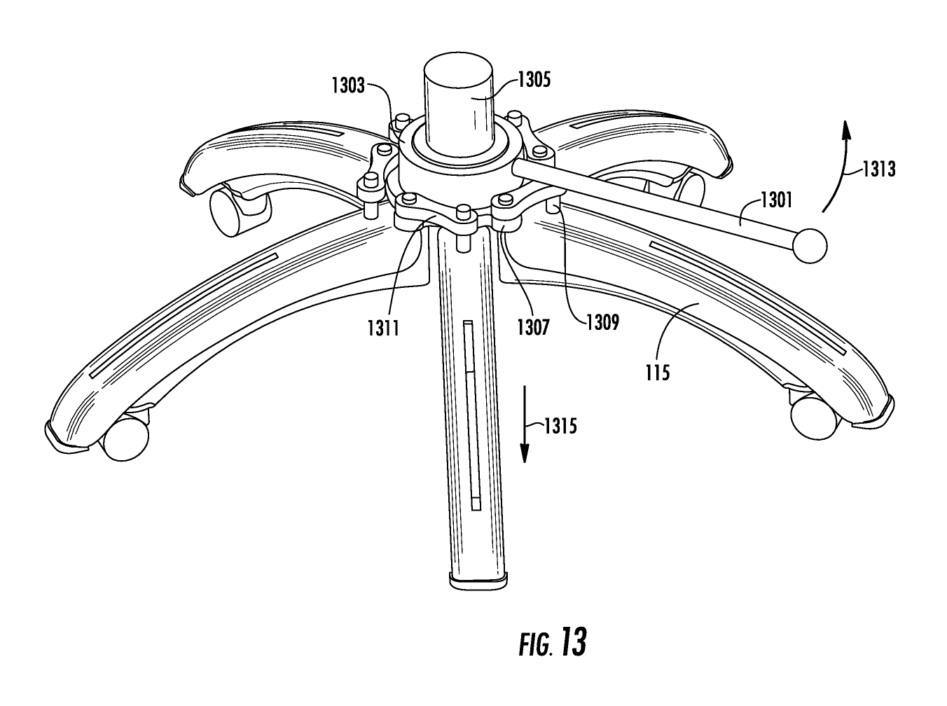

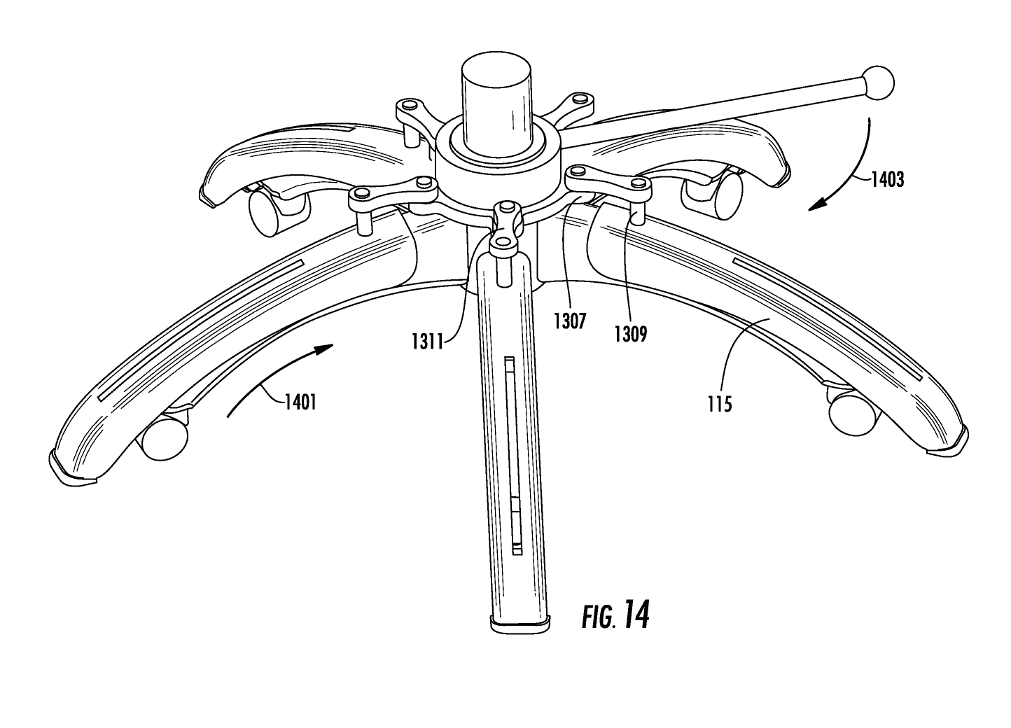

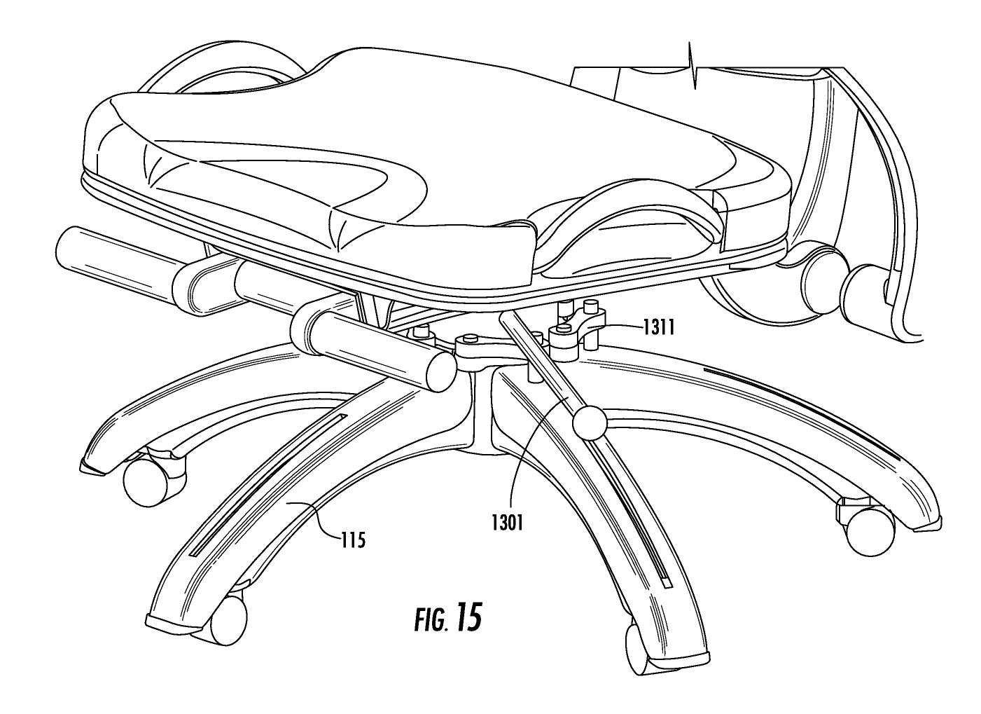

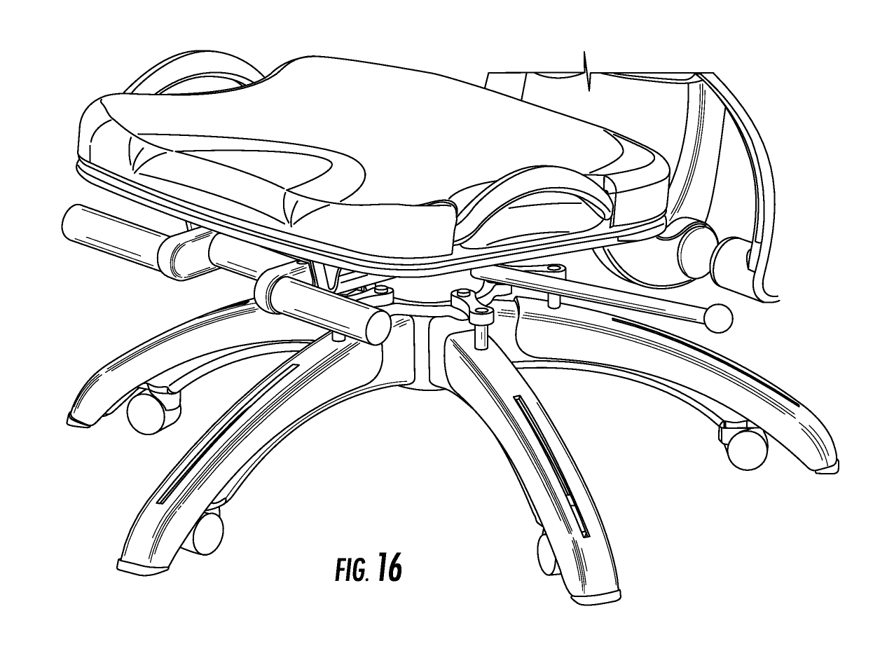

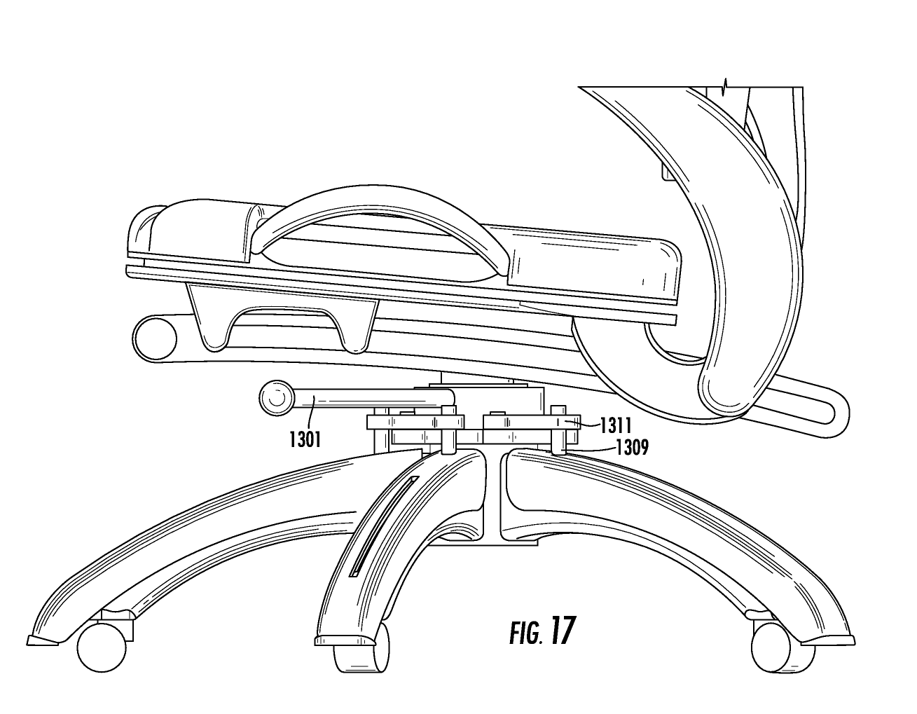

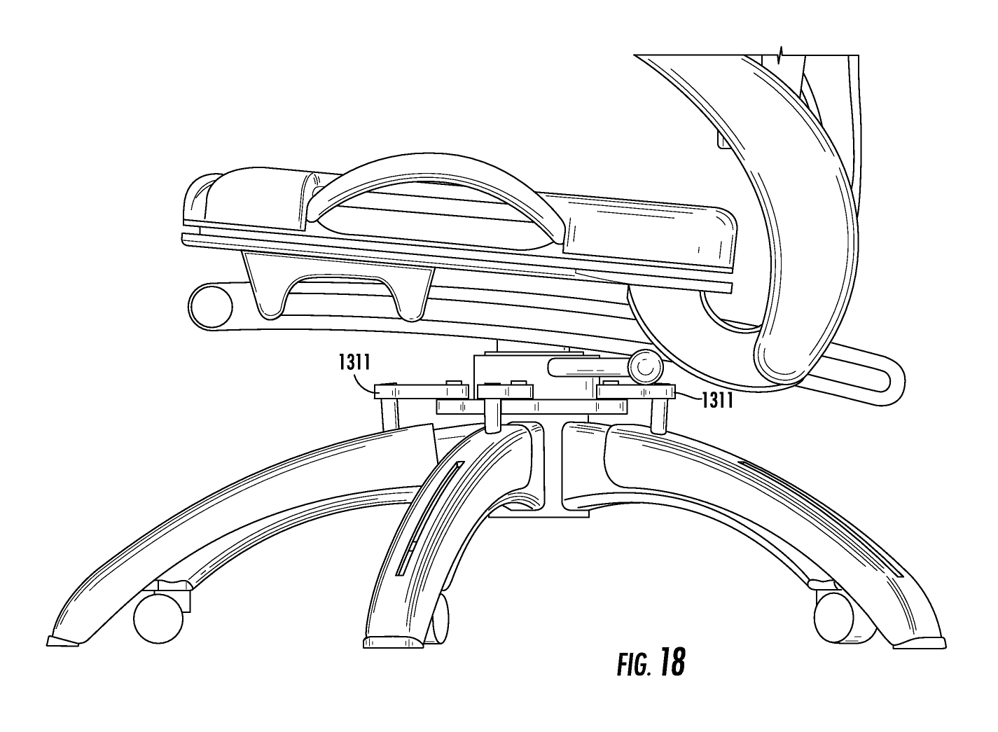

FIGS. 13-18 are exemplary views of a mobile chair stop system in mobile and stationary positions according to a third embodiment of the present invention. This embodiment depicts an exemplary “crank system” for enabling the mobile and stationary positions, via rotation to translation forces. FIGS. 13, 15 and 17 depict a chair in a mobile state, whereas FIGS. 14, 16 and 18 depict a chair in a non-mobile or stationary state.

In this exemplary embodiment, a mobile chair stop system is comprised of a disk member 1303 having an aperture adapted to allow the disk member 1303 to be rotatably installed onto a chair support column 1305. The disk member 1303 includes a plurality of attachment points 1307 which permit movable connection of chair stops 115. For example, such movable connection may be achieved via provision of a pivot arm 1311 having a first end pivotally connected to the disk attachment point 1307, and a second end pivotally coupled to a chair stop attachment point 1309. The pivot arm 1311 may be configured to be rotatable at each end relative to the fixed attachment points 1307, 1309. The chair stop attachment point 1309 may comprise an elongate rod fixedly attached to the chair stop 115, while the disk attachment point 1307 may comprise a similar member fixedly attached to the disk 1303.

To achieve a non-mobile or stationary mode, each chair stop 115 is caused to be extended to enable each stop pad 117 to contact the ground, thus preventing the chair wheels from rolling. According to one embodiment as shown in FIGS. 13-18, each chair stop is caused to be simultaneously extended by a series of mechanical events, e.g., by pushing the lever 1301 in a sideways direction 1313 (e.g., in a counterclockwise direction, though a clockwise direction may be contemplated). This in turn rotates the disk member 1303 accordingly (e.g., in a counterclockwise direction) and a force is exerted onto each pivot arm 1311, which causes the pivot arms 1311 to rotate into an extended position (e.g., as shown in FIGS. 14, 16 and 18).

In turn, each chair stop 115 is forced outwards in direction 1315 simultaneously. As described above, each chair stop 115 is caused to be extended for a suitable distance, such distance preferably sufficient to cause the ends of each chair stop 115 to firmly contact the floor or ground to achieve a secure grip. Preferably, each chair stop end includes a stop pad 117 to improve frictional grip and stability.

To achieve a mobile mode (shown here, e.g., in FIGS. 13, 15 and 17), each chair stop 115 is caused to be retracted to be lifted (e.g., to lift each stop pad 117) from the ground, thus allowing the wheels 113 to roll freely. To return to a mobile mode from a non-mobile mode, essentially a reverse series of events is carried out, namely, according to one embodiment as shown in FIGS. 13-18, each chair stop is caused to be simultaneously retracted by a series of mechanical events, e.g., by pushing the lever 1403 in the opposite direction 1403.

This causes the disk member 1303 to be rotated accordingly (e.g., here, in a clockwise direction) and each pivot arm 1311 to be simultaneously retracted such that each chair stop 115 is pulled inwards in direction 1401. Each chair stop 115 is caused to be retracted for a suitable distance, such distance preferably sufficient to cause the ends of each chair stop 115 to release any contact with the floor or ground, thus allowing the chair wheels 113 to roll freely.

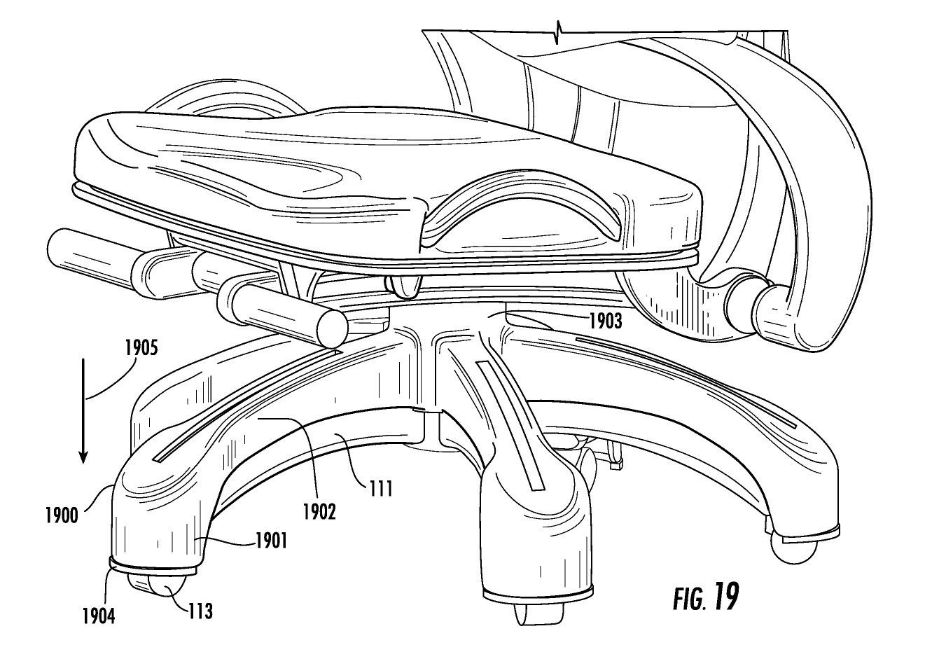

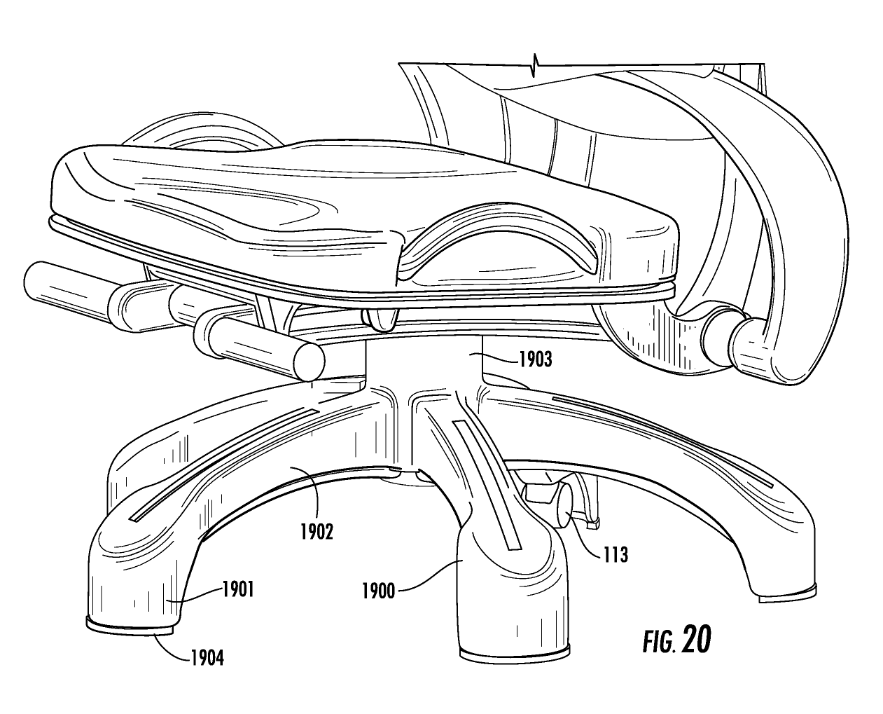

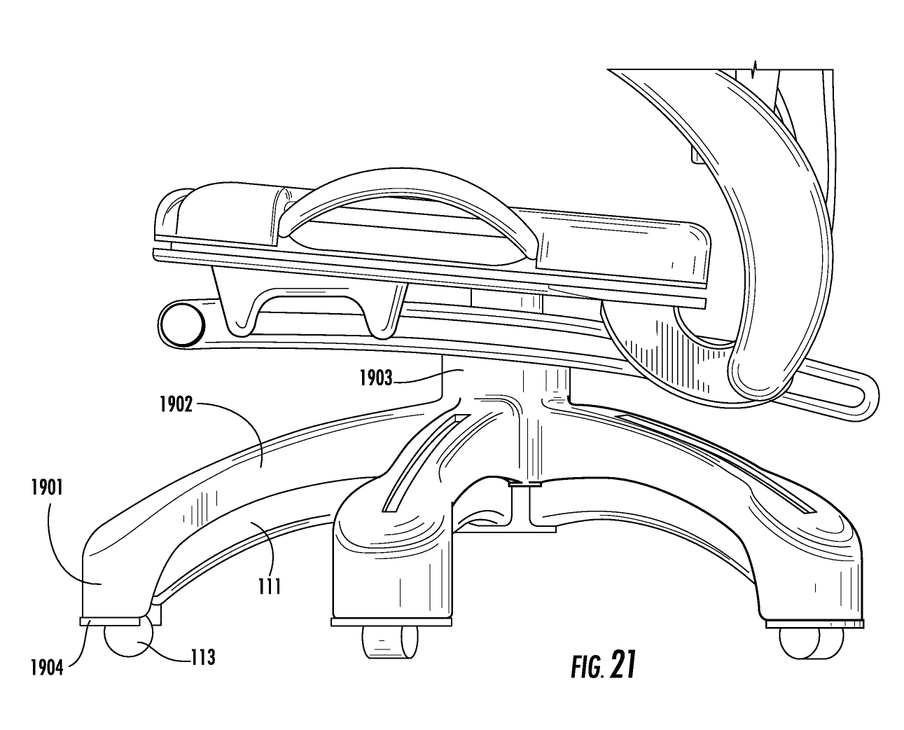

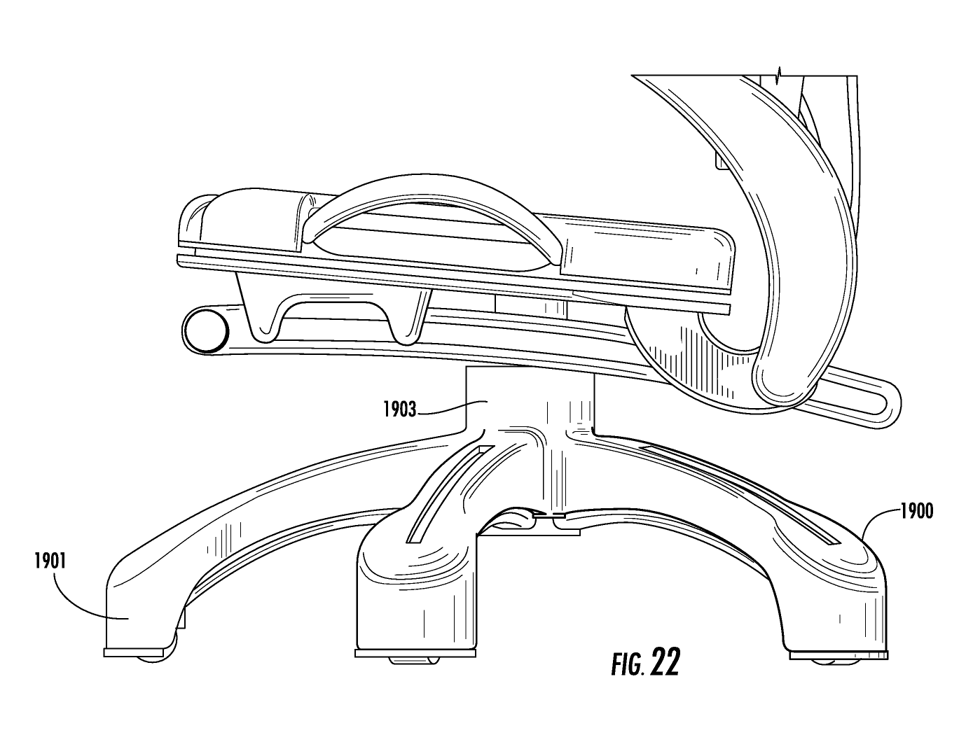

FIGS. 19-22 are exemplary views of a chair having a mobile chair stop system in mobile and stationary positions according to a fourth embodiment of the present invention. FIGS. 19 and 21 depict a chair in a mobile state, whereas FIGS. 20 and 22 depict a chair in a non-mobile or stationary state.

In this exemplary embodiment, a mobile chair stop system includes a top shroud member 1900, which may comprise a top leg shroud 1902 for covering at least a top and side portions of each radial chair leg 111, and a wheel shroud 1901 for covering at least a top and side portions of each wheel 113. The shroud 1900 may be functionally connected to a base cover 1903 which is slidable relative to the chair cylinder.

A bottom edge of the wheel shroud 1901 may include a grip edge 1904, preferably made of rubber, silicone, or other frictional, ‘grippy’ material. The wheel shroud 1901 may comprise a cup-like member with a hollow interior for surrounding each wheel 113, with each grip edge 1904 extending substantially around each wheel 113, for example, in a U-shape. Advantageously, this optimizes the surface area contact of the grip edge 1904 with the floor when in a stationary position, thus improving the braking action and minimizing movement of the chair.

The shroud member 1900 is slidable in a vertical direction relative to the legs 111. That is, the shroud member 1900 may be raised or lowered as desired by the user, for example, via the mechanism used for raising and lowering the chair seat. Alternate means for raising and lowering the shroud 1900 may be contemplated however, including direct manual adjustment and manipulation of the shroud 1900.

The exemplary depictions in FIGS. 19 and 21 depict the shroud 1900 in a raised position to enable a mobile state. To achieve a non-mobile or stationary mode as shown in FIGS. 20 and 22, the shroud member 1900 may be lowered in direction 1905 to enable the grip edge 1904 to frictionally contact the ground, thus acting as a brake and preventing movement of the chair.

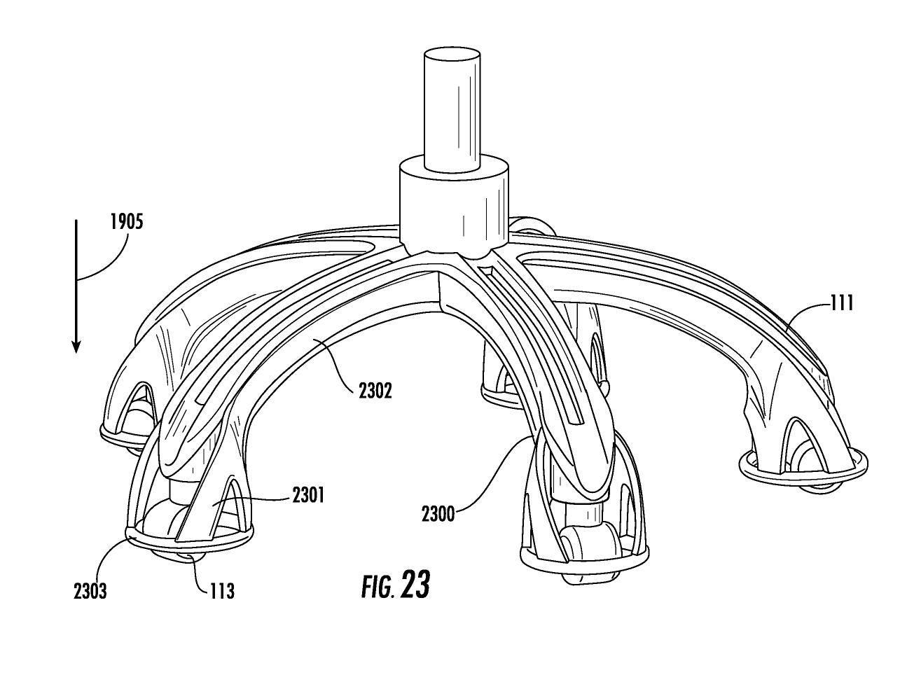

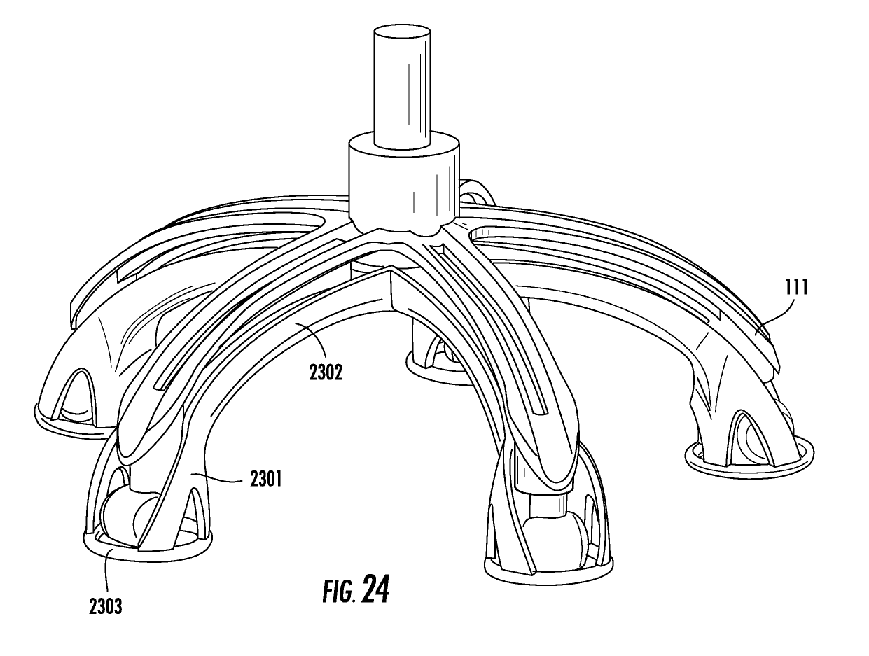

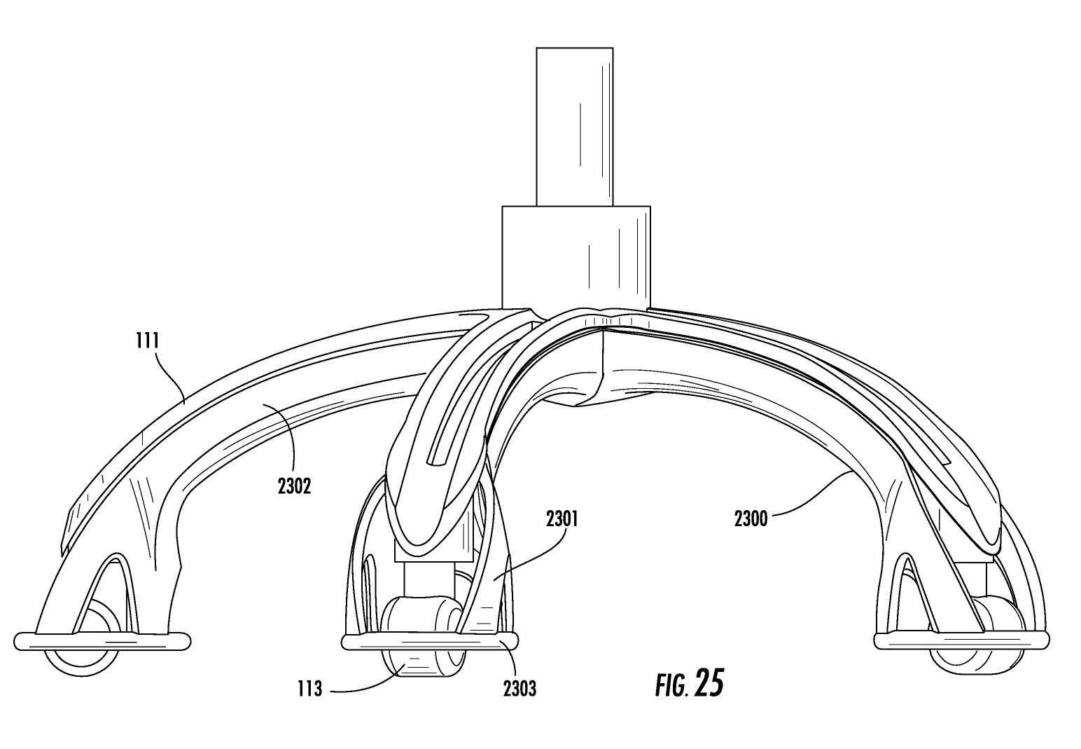

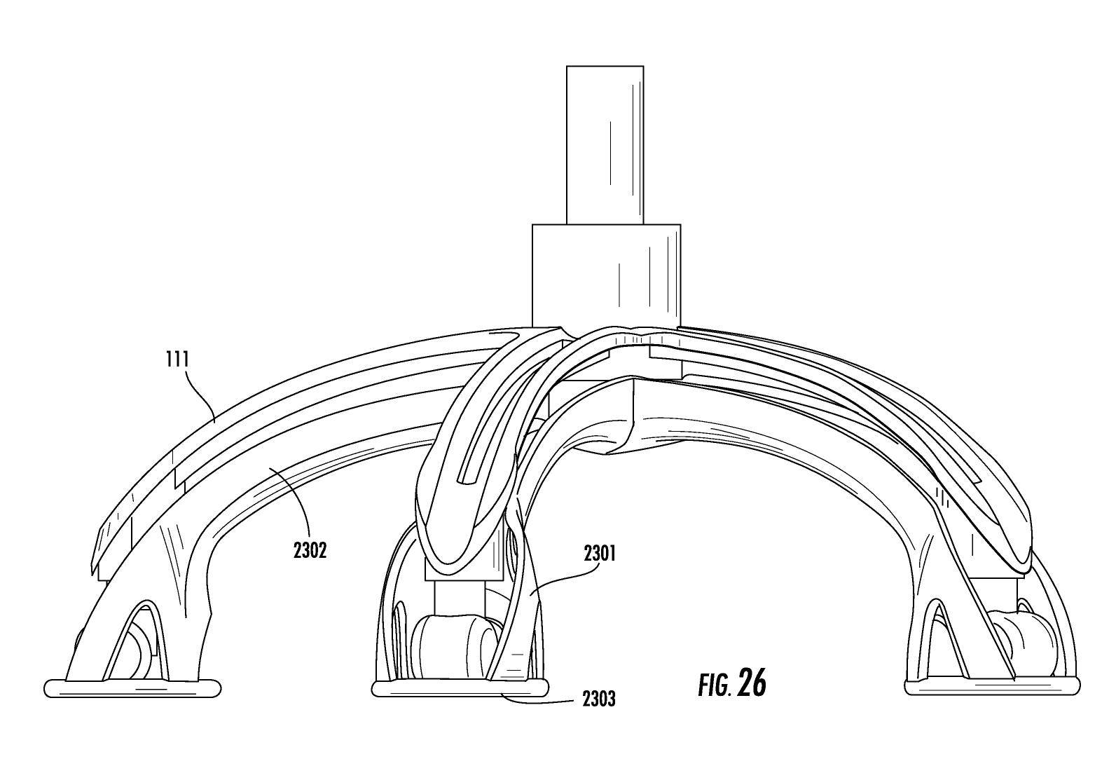

FIGS. 23-26 are exemplary views of a chair having a mobile chair stop system in mobile and stationary positions according to a fifth embodiment of the present invention. FIGS. 23 and 25 depict a chair in a mobile state, whereas FIGS. 24 and 26 depict a chair in a non-mobile or stationary state.

In this exemplary embodiment, a mobile chair stop system includes a bottom shroud member 2300, which may comprise a bottom leg shroud 2302 for covering at least a bottom and side portion of each radial chair leg 111, and a partial wheel shroud 2301 comprising a cage-like member for partially covering at least side portions of each wheel 113.

A bottom edge of the partial wheel shroud 2301 may include a grip edge 2303, preferably made of rubber, silicone, or other frictional, ‘grippy’ material. The partial wheel shroud 2301 may comprise a cage-like design for partially covering each wheel 113, thus allowing each wheel 113 to be visible. The cage-like member 2301 secures each grip edge 2303. Each grip edge 2303 is designed to entirely surround the perimeter of each wheel 113, for example, in an O-shape. Advantageously, this maximizes the surface area contact of the grip edge 2303 with the floor when in a stationary position, thus maximizing the braking action and minimizing movement of the chair.

The bottom shroud member 2300 is movable in a vertical direction relative to the legs 111. That is, the shroud member 2300 may be raised or lowered as desired by the user, for example, via the mechanism used for raising and lowering the chair seat. Alternate means for raising and lowering the shroud 2300 may be contemplated however, including direct manual adjustment and manipulation of the shroud 2300.

The exemplary depictions in FIGS. 23 and 25 depict the shroud 2300 in a raised position to enable a mobile state. To achieve a non-mobile or stationary mode as shown in FIGS. 24 and 26, the shroud member 2300 may be lowered in direction 1905 to enable the grip edge 2303 to frictionally contact the ground, thus acting as a brake and stabilizing force and preventing movement of the chair.

Advantageously, a chair stop system according to the present invention imparts dual functionality for mobile chairs, enabling them to be switched between stationary and mobile states. A stationary mode is effectively and securely achieved with minimal effort via a simultaneous extension of multiple chair stops in unison, upon a single force being exerted by the user. The orientation and configuration of the chair stops, e.g., in a radial pattern provide of maximum stability and minimizes movement of the chair. Moreover, immediate and effective enablement of a mobile state is achieved via a simultaneous retraction of the multiple chair stops, thus allowing the chair wheels to roll freely on the ground.

Although the embodiment which incorporates the teachings of the present invention has been shown and described in detail herein, those skilled in the art can readily devise many other varied embodiments that still incorporate these teachings. Having described preferred embodiments for a chair stop system (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

What is claimed:

1. A stop system for a mobile chair having wheels comprising:
a plurality of shroud members configured for covering each radial chair leg of the mobile chair, each shroud member being movable in a first direction to enable a mobile state of the chair and in a second direction to enable a stationary state of the chair.

2. The stop system of claim 1, wherein each shroud member comprises a top shroud member.

3. The stop system of claim 2, wherein said top shroud member comprises a wheel shroud and a top leg shroud.

4. The stop system of claim 3, wherein the wheel shroud comprises a cup-like member adapted to cover at least the top and side portions of each wheel.

5. The stop system of claim 3, wherein the top leg shroud is adapted to cover at least a top and side portion of each radial leg.

6. The stop system of claim 1, wherein the first direction comprises an upwards direction, causing each shroud member to be lifted from the ground.

7. The stop system of claim 1, wherein the second direction comprises a downwards direction, causing each shroud member to frictionally contact the ground.

8. The stop system of claim 1, wherein each shroud member includes a grip edge disposed at each end and adapted to frictionally contact the ground when the chair is in a stationary state.

9. The stop system of claim 1, wherein each shroud member comprises a bottom shroud member.

10. The stop system of claim 9, wherein said bottom shroud member comprises a partial wheel shroud and a bottom leg shroud.

11. The stop system of claim 10, wherein the partial wheel shroud comprises a cage-like member adapted to partially surround side portions of each wheel.

12. The stop system of claim 10, wherein the bottom leg shroud is adapted to cover at least a bottom and side portion of each radial leg.

13. A chair stop system for a mobile chair comprising:
a plurality of chair stop members adapted for covering at least a top portions of each radial chair leg of the mobile chair, each chair stop member being slidable in a first direction to enable a mobile state of the chair and in a second direction to enable a stationary state of the chair.

14. The chair stop system of claim 13, wherein each chair stop member comprises a sheath-like member adapted to substantially extend along the length of each chair leg.

15. The chair stop system of claim 13, wherein each chair stop member is adapted to be slidable relative to a longitudinal axis of each chair leg.

16. The chair stop system of claim 13, wherein each chair stop member includes a stop pad disposed at each end for frictionally contacting the ground when the stationary state of the chair is enabled.

17. The chair stop system of claim 13, wherein the first direction comprises a retracted state wherein each chair stop member is slid radially in an inwards direction, causing each chair stop member to be lifted from the ground.

18. The chair stop system of claim 13, wherein the second direction comprises an extended state wherein each chair stop member is slid radially in an outwards direction, causing each hair stop member to frictionally contact the ground.

19. The chair stop system of claim 13, wherein the plurality of chair stops are caused to be simultaneously slidable in said first and second directions by a series of mechanical events.

20. The chair stop system of claim 19, wherein said series of mechanical events include at least one of a cam system, a cylinder push system or a crank system.
